(19) United States
(12) Patent Application Publication
(10) Pub. No.: US 2012/0114792 A1
(43) Pub. Date: May 10, 2012

(54) REDUCED STUCK ALCOHOLIC FERMENTATIONS IN PRODUCTION OF ALCOHOLIC BEVERAGES

(76) Inventors: Kristine Bjerre, Copenhagen N (DK); Johannes Maarten Van Den Brink, Herlev (DK)

(21) Appl. No.: 13/382,388

(22) PCT Filed: Jul. 6, 2010
(86) PCT No.: PCT/EP10/59603

§ 371 Date: Jan. 5, 2012

(30) Foreign Application Priority Data
Jul. 10, 2009 (EP) 09165165.3

(51) Int. Cl. C12G 3/02

(52) U.S. Cl. 426/15; 426/11

(57) ABSTRACT

A method for production of an alcoholic beverage wherein the method significantly decreases the risk of unwanted stuck alcoholic fermentations. The method involves addition of glucose isomerase to the beverage starting solution.

### FIELD OF THE INVENTION

The present invention relates to a method for production of alcoholic beverages wherein the method significantly decreases the risk of unwanted stuck alcoholic fermentations. The method involves addition of glucose isomerase to the beverage starting solution.

### BACKGROUND ART

It is known to the skilled person that a glucose/fructose ratio significantly different from 1:1 during production of alcoholic beverages may result in stuck alcoholic fermentations, i.e. the yeast is not fermenting all the sugar and it may therefore result in an alcoholic beverage which is too sweet.

This may be a significant problem for industrially relevant alcoholic beverage productions.

To the best knowledge of the present inventors, no industrially relevant solution to this stuck alcoholic fermentation problem is presently available.

International PCT application with application number PCT/EP2008/068149 was filed 22 Dec. 2008. Applicant is Chr. Hansen A/S and the application was not published at the filing date of this present application.

PCT/EP2008/068149 describes a method for production of wine from grape juice involving the use of enzymes as described by the present invention. Use of other beverage starting solutions as the basis for alcoholic fermentation is not described in PCT/EP2008/068149.

### SUMMARY OF THE INVENTION

The problem to be solved by the present invention is to provide a new method for production of an alcoholic beverage, wherein the method significantly decreases the risk of unwanted stuck alcoholic fermentations.

The present inventors found that addition of glucose isomerase to the beverage starting solution (hereafter also referred to as “solution”) maintains the ratio glucose/fructose in the solution at a ratio around 1:1, which significantly decreases the risk of unwanted stuck alcoholic fermentations. For further details, see working examples herein.

As mentioned above, it is known to the skilled person that a glucose/fructose ratio significantly different from 1:1 may result in stuck alcoholic fermentations, i.e. the yeast is not fermenting all the sugar and the resulting beverage may appear too sweet.

The enzyme of particular relevance in the method of the present invention is glucose isomerase EC 5.3.1.5 (official name Xylose isomerase). However, as known to the skilled person it may also be termed “glucose isomerase”. Glucose isomerase is for instance the name used in relevant commercial products of this enzyme class, such as e.g. the commercial product used in working examples herein.

The herein relevant and well known reaction catalyzed by glucose isomerase in typical beverage starting solution i.e. a solution comprising glucose and fructose is as follows:

D-glucose<=>D-fructose.

As known to the skilled person this enzyme class may also catalyze the reaction:

D-xylose<=>D-xylulose.

This xylose related reaction is less relevant herein.

Before the yeast alcohol fermentation has started, typical solutions used for alcoholic fermentation generally have a glucose/fructose ratio of around 1:1.

It is known to the skilled person that yeast “prefers” glucose over fructose during the yeast alcohol fermentation. Said in another way, the glucose may preferably first be metabolized by the yeast and this may result in a glucose/fructose ratio lower than 1:1 in the solution.

One theory for the herein described positive effect of using glucose isomerase is that the glucose removed by e.g. the yeast during alcohol fermentation may create a situation in the solution, where the glucose/fructose ratio gets lower than 1:1 (one gets “too much” fructose-“too little” glucose). The glucose/fructose equilibrium on which the glucose isomerase reacts is consequently “forced” to the left=>fructose is converted to glucose to “recover” the glucose/fructose ratio of 1:1=>significantly reducing the risk of stuck alcoholic fermentations.

Before yeast alcoholic fermentation O₂ is present in the unfermented solution (beverage starting solution). As known to the skilled person, normal yeast fermentation generally consists of two parts:
Part 1
Aerobic growth (Oxygen is present)
This is the initial rapid growth process where the yeast doubles its cell number roughly every 4 hours. (Usually 24-72 hours)
Part 2
Anaerobic fermentation (No oxygen present)
Slower activity and the yeast ferments sugar (both glucose and fructose), converting it to alcohol (sugar=>2 ethyl alcohol+2 CO₂) rather that increasing the number of yeast cells. (This process can take from days to weeks depending on the yeast and the recipe).

Accordingly, during the yeast fermentation the O₂ will sooner or later disappear. However, the glucose isomerase is active with or without the presence of O₂ and can therefore work both before the actual start of the alcohol yeast fermentation or during the actual alcohol yeast fermentation.

Accordingly, a first aspect of the invention relates to a method for production of an alcoholic beverage, comprising the following steps:
(1): treating a beverage starting solution during the alcohol yeast fermentation with an effective amount of glucose isomerase to maintain the glucose/fructose ratio closer to 1:1 in the solution;
   and thereafter,
(2): further adequate steps to produce the alcoholic beverage of interest, and with the proviso that the beverage starting solution is NOT grape juice as described in PCT/EP2008/068149.

As shown herein glucose isomerase is relatively stable during normal production conditions of alcoholic beverages. Accordingly, the effective amount of glucose isomerase may be added before the actual start of the alcohol yeast fermentation and it will then still work satisfactory during the alcohol yeast fermentation. See working example herein, where it is added to unfermented grape juice.

Alternatively, the effective amount of glucose isomerase may be added during the alcohol yeast fermentation. If it is added during the alcohol yeast fermentation it is preferably done in the beginning of the fermentation, e.g. at roughly the same time as the yeast is added to the solution.

### DEFINITIONS

All definitions of terms are in accordance with the general understanding of the person of skill in the art within the technical fields relating to alcohol fermentation.

The term “maintain the glucose/fructose ratio closer to 1:1” of step (1) of the first aspect in relation to treatment of the solution with an effective amount of glucose isomerase may be seen as directly relating to using an effective amount of the glucose isomerase. As explained above, the herein relevant function of the glucose isomerase is to try to “reestablish” the glucose/fructose ratio of 1:1. Accordingly, by addition of glucose isomerase as described herein one automatically obtain a ratio closer to 1:1 in the solution as described herein.

Embodiment of the present invention is described below, by way of examples only.

### DETAILED DESCRIPTION OF THE INVENTION

### Glucose Isomerase

The glucose isomerase to be used in the present method may be obtained from numerous different suitable sources such as relevant commercially available enzyme products.

As known to the skilled person there are numerous different commercially available glucose isomerase enzyme products on the market with enzymes that work within the normal conditions of alcohol fermentation (e.g. relevant pH values, temperature etc).

In the working examples below the following commercially available enzyme product was used:
glucose isomerase: Product from Sigma (# G4166—50 g). Catalogue number—see a working example herein.

### Preferred Production Parameters—Step 1 of First Aspect

As known to the skilled person, changes in the beverage production procedures alter the organoleptic properties of the beverage product. Therefore, a close-fit between the usual beverage production procedures and practice of the method as described herein is preferred. Consequently, through practicing of this invention no adverse effects are observed with respect to taste and bouquet of the resulting beverage.

Essentially, the skilled manufacturer of alcoholic beverages should preferably not change anything in his preferred production process, except the addition of glucose isomerase as described herein.

Enzyme catalyzed processes are usually conducted within the pH optimum of the enzyme. Preferred practice of this invention is to treat the unfermented solution (beverage starting solution) without adjusting the pH thereof. Fortunately, suitable relevant commercial available products of the enzymes as used herein exhibit adequate activity and stability in herein relevant steps of the production process.

It is to be understood that any enzyme as described herein can be used in the method according to the invention, provided that it exhibits a reasonable relevant activity and stability at the pH and temperature prevailing during the production of the specific alcoholic beverages. Thus, both soluble and immobilized enzyme preparations may be used, even if soluble enzyme preparations are usually preferred.

In a preferred embodiment the relevant enzyme preparation(s) is a solid water soluble preparation, preferably a non-dusting preparation. The storage stability of a solid preparation is better than the storage stability of a liquid preparation, and also, it is unnecessary to add any conservation agents. It is recommended, though, that the user dissolve the solid form agent in a small amount of water immediately before use.

It is easy for the worker skilled in the art to find out how much enzyme of a given kind is needed for a given application.

For instance, depending on the details of treatment times and temperatures a glucose isomerase activity roughly between about 100 and 5,000,000 international units per hl of solution will be appropriate.

Thus, it provides no additional value specifying appropriate dosages of the enzyme as this will be relatively easy to test under the specific process parameters. As illustrated hereinafter, the relevant amounts applied in the examples are within the above levels and it is assumed that the above ranges cover any relevant applications.

As known to the skilled person, an international unit is defined as that amount of the enzyme that catalyses the conversion of 1 micro mole of substrate per minute. The conditions also have to be specified. As known to the skilled person one usually takes a temperature of 30° C. and the pH value and substrate concentration that yield the maximal substrate conversion rate.

Herein the international units are defined as described above and according to the art, i.e. determined at a temperature of 30° C. and the pH value and substrate concentration that yield the maximal substrate conversion rate.

As known to the skilled person, the optimal pH value and optimal substrate concentration may vary for a specific enzyme of interest. However, it is easy to identify this optimal pH and substrate concentration since it is e.g. generally given on the product documentation for a relevant commercial enzyme product. Further, in general for a specific enzyme of interest it is routine work to identify parameters such as optimal pH and substrate concentration.

The specific beverage starting solution (solution) used in the production method according to the present invention act as substrate for the enzyme. It should be obvious that presence of glucose and fructose in the beverage starting solution is an important factor determining if the present method is of interest in production of the specific beverage. Typically, beverages manufactured from fruit containing solutions would benefit from the present invention.

In one embodiment, the starting solution is not grape juice.

Depending on the specific substrate (beverage starting solution) the sugar content and ratios between glucose and fructose may vary. In e.g. apples the ratio glucose:fructose is 30:70, in mango the ratio is 24:76, in pineapple the ratio is 43:57, and in strawberry the ratio is 20:80. As known to the person skilled in the art, these ratios may vary depending on climate and growth conditions as well as time of harvest. The ratios will be relevant for selecting optimal dosages of the enzymes. Based on this information, which is readily available, the skilled person will have no difficulties in selecting the optimal dosage of enzyme for the particular application.

In a preferred embodiment a glucose isomerase activity roughly between about 5,000 and 500,000 international units per hl of solution will be appropriate.

In a preferred embodiment the effective amount of the glucose isomerase enzyme during step (1) is so that at the end of yeast alcohol fermentation the sugar content in the solution is less than 4 g/l, more preferably less than 1 g/l and even more preferably less than 0.1 g/l.

In working example 2, table II herein it can be seen that addition of glucose isomerase resulted in no measurable (“0”) sugar in the grape juice after fermentation—in other words, addition of glucose isomerase completely prevented unwanted stuck fermentation. As understood by the skilled person, if there is stuck fermentation yeast will not use all the sugar and there will be a significant amount of sugar left in the solution at the end of yeast alcohol fermentation.

If here is as little sugar left as specified under point (A) above it means there has been no significant unwanted stuck fermentation.

Due to the fact that the aroma, the taste and the bouquet of alcoholic beverages are properties which are extremely sensitive, it could not be predicted whether the alcoholic beverage produced according to the invention would possess the wanted properties. Additionally, it was considered whether the alcoholic beverage produced according to the invention, with soluble glucose isomerase preparation, would contain traces of inactive glucose isomerase and therefore would differ from a conventionally produced beverage. However, it has been found that the alcoholic beverage produced according to the invention possesses all normal properties of the conventionally produced product, including taste and bouquet.

### Preferred Production Parameters—Step 2 of First Aspect

Conduct of step 2 of first aspect, i.e., further adequate steps to produce the alcoholic beverage of interest is an obligatory step of the method of the invention. However, no detailed discussion of this step needs to be provided herein since conduct of conventional practices in manufacturing of alcoholic beverages are contemplated expressly and those practices are well known to persons skilled in the art of alcoholic fermentation and enology (oenology).

For instance, these further adequate steps may be a relevant storage step.

Alcoholic Beverages with Lower Content of Alcohol—Addition of Glucose Oxidase

Due to global warming fruit and berries worldwide contain more sugar. This sugar is converted to alcohol in the alcoholic fermentation, resulting in final products with increased alcohol levels.

In U.S. Pat. No. 4,675,191 (Novo Industri, Denmark—published 1987) a method for reducing alcohol content in wine involving use of the enzyme glucose oxidase is described. With respect to the described method column 2, lines 25-29 read:
“The method of this invention comprises treating unfermented grape juice with glucose oxidase in the presence of oxygen, thereby converting glucose in the grape juice into gluconic acid and thereafter fermenting the so-treated grape juice.”

Accordingly, U.S. Pat. No. 4,675,191 describes that glucose oxidase may remove some glucose from the unfermented grape juice. Less sugar in the grape juice implies less alcohol content in the final wine.

Glucose oxidase has been used in some of the working examples herein in order to make a wine with lower content of alcohol. From these examples it can clearly be seen that presence of glucose isomerase as described herein significantly improves a wine process involving the use of glucose oxidase to lower the content of alcohol.

One reason for glucose isomerase related improvement is that glucose isomerase significantly reduces the stuck fermentation as discussed herein (see e.g. examples 2 and 3 herein).

Accordingly, in an embodiment of the present invention before the start of the alcohol yeast fermentation of step (1) of the method the following step is performed:
treating an unfermented beverage starting solution with an effective amount of glucose oxidase in the presence of oxygen for a period of time adequate to convert at least a portion of the glucose in the solution to gluconic acid.

The addition of glucose oxidase of step (A) may essentially be done as described in U.S. Pat. No. 4,675,191. In fact the manufacturer will generally not change anything of relevance to normal practice—except addition of the glucose oxidase.

Glucose oxidase (EC 1.1.3.4) catalyzes the following reaction in the solution:

Beta-D-glucose+O₂<=>D-glucono-1,5-lactone+H₂O₂

Within the solution generated “D-glucono-1,5-lactone” is spontaneously converted into gluconic acid. Accordingly, D-glucono-1,5-lactone is removed and the equilibrium is therefore going to the right=>glucose is removed from the solution.

If the enzyme preparation also has catalase activity the created H₂O₂ is also removed=>equilibrium is therefore going even more to the right=>more glucose is removed. Involvement of catalase activity is a preferred embodiment herein. Catalase (EC 1.11.1.6) catalyzes the reaction:

2H₂O₂<=>O₂+2H₂O

If glucose oxidase is used as described in step (A) above, it is preferred that glucose isomerase is added together with the glucose oxidase to the unfermented solution. This is done in a working example herein with very positive results.

Below is discussed preferred embodiment in relation to this step (A) of treating unfermented solution with an effective amount of glucose oxidase.

One contemplated theory explaining the significant removal of glucose resulting from combined use of glucose oxidase and isomerase is as follows. The glucose removed by the glucose oxidase creates a situation in the solution, where the glucose/fructose ratio becomes lower than 1:1 (“too much” fructose-“too little” glucose). The glucose/fructose equilibrium on which the glucose isomerase reacts is consequently “forced” to the left=>fructose is converted to glucose to “recover” the glucose/fructose ratio of 1:1=>the glucose oxidase receives “newly” created glucose to work on and thereby more of the total sugar is removed (both glucose and fructose) from the solution.

As discussed above, the maintenance of the glucose/fructose ratio of 1:1 also has the advantage of significantly reducing the risk of stuck alcoholic fermentations.

The glucose oxidase to be used in the method as described herein may be obtained from numerous different suitable sources such as relevant commercially available enzyme products.

As known to the skilled person there are numerous different commercially available glucose oxidase enzyme products on the market with enzymes that works within the normal conditions of alcoholic beverage production parameters (e.g. relevant pH values, temperature etc).

In the working examples below were used following commercially available enzyme products:
glucose oxidase: Hyderase® (from Amano).

An advantage of the Hyderase® product is that it also comprises catalase activity.

As previously mentioned, it is easy for the worker skilled in the art to find out how much enzyme of a given kind is needed for a given solution and a desired sugar conversion.

For instance, depending on the details of treatment times and temperatures a glucose oxidase activity roughly between about 1,000 and 50,000,000 international units per hl of solution will be appropriate.

In a preferred embodiment there is used a glucose oxidase activity roughly between about 15,000 and 5,000,000 international units per hl of solution.

In a preferred embodiment the effective amount and the period of time for the two glucose oxidase/isomerase enzymes during step (A) is so that the sugar content in the solution is reduced by at least 10%, more preferably at least 14% and even more preferably at least 17%.

As discussed above, in working examples herein the sugar content (both glucose and fructose) was reduced by 19%.

In the following examples, grape juice is used to exemplify the principle of the invention. It is to be understood that the manufacturing processes, when other beverage starting solutions are used, are very similar and therefore the teaching and examples herein will allow the person of skill in the art to work the invention in production of any specific beverage.

### EXAMPLES

### Example 1

### Enzymatic Sugar Reduction in Grape Juice—Example of Step (1) of First Aspect

One possible way to reduce the final alcohol content in wine and any other alcoholic beverage is to reduce the sugar concentration in the solution before the alcoholic fermentation. Therefore an enzymatic treatment of grape juice was performed in order to reduce the total sugar content.

Three independent experiments were performed using two replicates in each case. In each sample 200 ml grape juice (Pinot Blanc 2007, Germany, pasteurized) was added to a glass flask and continuously mixed with a magnetic stirrer. The samples were aerated throughout the experiment.

Either 100 mg glucose oxidase (Hyderase, Amano, >15,000 u/g, corresponding to 150,000 u per hl solution) or both 100 mg glucose oxidase and 1 g glucose isomerase (Sigma, G4166—50 g, >350 u/g, corresponding to 35,000 u per hl solution) were added to the flasks. The incubation was allowed to run at room temperature for 3 days.

Samples were taken just before addition of the enzymes and after 3 days. Samples were analyzed for the presence of glucose and fructose using a commercial UV based assay supplied by Boehringer Mannheim/R-biopharm (catalog number 10 139 106 035) following the protocol provided by the manufacturer. The results of this experiment are summarized in Table I below.

TABLE I
Enzymatic sugar (glucose and fructose) reduction in grape juice.

| | | total sugar | Reduction total sugar |
|---|---|---|---|
| Day | Treatment | (g/l) | (%) |
| 0 | GOX | 230 | 0 |
| | GOX + isomerase | 235 | 0 |
| 3 | GOX | 202 | 12 |
| | GOX + isomerase | 190 | 19 |

GOX = glucose oxidase

### Conclusion

These results of this example 1 show that a process only using glucose oxidase gave a total sugar reduction of around 12% and extra addition of glucose isomerase significantly increased this to a sugar reduction of around 19%. Less sugar in the grape juice implies less alcohol content in the wine, or other alcoholic beverage.

### Example 2

### Yeast Fermentation of Treated Grape Juice—Example of Both Step (1) and Step (2) of First Aspect

A full simulation of a general winemaking process was done at laboratory scale. In this experiment it was shown that the enzymatic treatment did have an effect on the final alcohol level without negatively influencing major wine production parameters like the alcoholic fermentation or the malolactic fermentation. The complete experiment was carried out at room temperature, approximately 22° C. Six experiments were performed with each four liters of grape juice (Pinot Blanc 2007, Germany, pasteurized) in fermentation flasks. The pH of the grape juice was not adjusted and no material was added other than the enzymes described in this example.

The grape juice was preincubated for three days with enzymes as described below, followed by the alcoholic fermentation of 11 days and a malolactic fermentation of 10 days.

### Enzymatic Treatment

The six flasks were divided in three groups of two flasks.

The grape juice in group 1 was preincubated for three days with 0.5 g/l glucose oxidase (Hyderase, Amano, >15,000 u/g, corresponding to 750,000 u per hl solution), the grape juice in the second group with 0.5 g/l glucose oxidase and 2 g/l Glucose Isomerase (Sigma, G4166—50 g, >350 u/g, corresponding to 70,000 u per hl solution) and the grape juice in the control group was not treated with enzymes. Following enzyme addition, the flasks were vigorously aerated for three days in the presence of the enzymes, before the alcoholic fermentation was started. Aeration is important since oxygen is required in the glucose oxidase mediated enzymatic conversion.

### Alcoholic Fermentation

The alcoholic fermentation was started by inoculation with rehydrated freeze dried wine yeast (Saccharomyces cerevisiae Merit. Ferm, Chr. Hansen, 0.1 g/l) to a final concentration of 9E+05 CFU/ml. Rehydration was performed in peptone water (15 g/l Tryptone, Oxoid L 42.9 g/l NaCl, 1.14 g/12% antifoam 1510, BHD 63215) for 10 minutes at room temperature.

At this point the aeration was stopped and the process became depleted for oxygen during the following days as a result of the yeast metabolism. The alcoholic fermentation was allowed to run for eleven days at room temperature which resulted in almost complete conversion of all sugar to alcohol.

### Malolactic Fermentation

Following the alcoholic fermentation, the malolactic fermentation was started. The aim of this part of the process is to convert malate into lactate which results in a more pleasant sensoric sensation and thus is an important part of the wine producing process. The malolactic fermentation is mostly performed by the bacteria Oenococcus oeni. It would be highly undesirable if growth of O. oeni would be impaired by the enzymatic treatment of the grape juice.

Eleven days after the start of the alcoholic fermentation the malolactic fermentation was started by addition of O. oeni (Viniflora, Chr. Hansen. Batch no.: 2711097) to the fermented grape juice. Freeze dried O. oeni (0.7 g of 8.2 E+11 CFU/g) was allowed to rehydrate for 10 minutes in 100 ml of peptone water 15 g/l Tryptone, Oxoid L42, 9 g/l NaCl, 1.14 g/12% antifoam 1510, BHD 63215). Three ml was added to 4000 ml of fermented grape juice, resulting in a final concentration of 4.3*10⁶ CFU/ml. This was allowed to stand for another 10 days at room temperature.

### Results

### Effect of Enzymatic Treatment on Alcohol Levels

Glucose and fructose levels were measured using a commercial UV based assay supplied by Boehringer Mannheim/R-biopharm (catalog number 10 139 106 035), using the protocol supplied by the provider.

TABLE II
Sugar levels at the start end of the alcoholic fermentation.

| | | Glucose | Fructose | Total sugar |
|---|---|---|---|---|
| day | Treatment | (g/l) | (g/l) | (g/l) |
| 0 | Control | 110 ± 3 | 118 ± 1 | 229 ± 4 |
| | GOX | 96 ± 5 | 124 ± 3 | 225 ± 9 |
| | GOX + Isomerase | 106 ± 22 | 119 ± 5 | 225 ± 25 |
| 11 | Control | 0 ± 0 | 8 ± 2 | 8 ± 2 |
| | GOX | 24 ± 17 | 59 ± 11 | 83 ± 27 |
| | GOX + Isomerase | 0 | 0 | 0 |

Alcohol was measured at different days during the alcoholic fermentation using the Dr. Rebelein titration method as described in the literature (Bestimmung des alkoholgehalts nach Dr. Rebelein. Issued by: C Schliesmann Kellerie-Chemie GmbH & Co. KG, Auwiesenstrasse 5, 74523 Schwäbische Hall (2001)). In the untreated grape juice the fermentation was almost complete, reaching a final alcohol level of 12.7% at the end of the process. When the juice was pretreated with both glucose oxidase and glucose isomerase the sugar fermentation was complete but still the final level of alcohol was significantly lower (11.8%).

The low levels of alcohol found when the juice was pretreated with glucose oxidase only, are a result of incomplete fermentation. The glucose oxidase treated juice in this experiment is not usable in normal winemaking due to the high levels of rest sugar—especially fructose—at the end of fermentation (Table II).

Accordingly, the extra addition of glucose isomerase helped to maintain the ratio glucose/fructose in the grape juice at a ratio around 1:1, which significantly decreases the risk of unwanted stuck alcoholic fermentations as shown when using only GOX.

Further, the experiment with isomerase removed all sugar while still some fructose sugar (8 g/l) was present in the control (untreated grape juice). This demonstrates that isomerase as such prevent stuck fermentations.

TABLE III
Alcohol levels during the fermentation.

| Day | Treatment | Alcohol (vol %) |
|---|---|---|
| 0 | Control | 0 |
| | GOX | 0 |
| | GOX + Isomerase | 0 |
| 7 | Control | 10.9 ± 0.3 |
| | GOX | Nd |
| | GOX + Isomerase | 10.7 ± 0.5 |
| 11 | Control | 12.3 ± 0.1 |
| | GOX | 7.5 ± 1.3 |
| | GOX + Isomerase | 11.7 ± 0.1 |
| 16 | Control | 12.7 ± 0.1 |
| | GOX | 9.3 ± 0.6 |
| | GOX + Isomerase | 11.8 ± 0.01 |

At day 11 the malolactic fermentation was started. The alcohol levels in the glucose oxidase (GOX) pre-treated samples are in italics to indicate that these values are the result of a severely delayed alcoholic fermentation.
Nd: not determined

### Conclusion

The results of this example 2 shows that GOX+Isomerase significantly lowered alcohol percentage to 11.8% as compared to 12.7 of control.

Further, the extra addition of glucose isomerase helped to maintain the ratio glucose/fructose in the grape juice at a ratio around 1:1, which significantly decreases the risk of unwanted stuck alcoholic fermentations as compared to using GOX alone.

The low levels of alcohol (9.3%) found when the juice was pretreated with glucose oxidase only, are a result of incomplete fermentation—in other words unwanted stuck alcoholic fermentations. The glucose oxidase treated juice in this experiment is not usable in normal winemaking due to the high levels of rest sugar—especially fructose—at the end of fermentation (Table II).

Further, the experiment with isomerase removed all sugar while still some fructose sugar (8 g/l) was present in the control (untreated grape juice). This demonstrates that isomerase as such prevents stuck fermentations.

### Example 3

### Growth of Yeast During the Alcoholic Fermentation—Addition of Isomerase Significantly Reduces Stuck Alcoholic Fermentation

It is known to the skilled person that stuck fermentations typically arise when fructose concentrations are considerably higher than glucose concentrations. During the alcoholic fermentation the glucose/fructose ratio, which is 1:1 at the start of the alcoholic fermentation, may change to a negative value, resulting in a delayed fermentation.

In this example 3a delayed (stuck) fermentation was induced by treatment of the juice with Glucose oxidase alone.

In order to investigate the effect of glucose isomerase on the ability of yeast to grow and survive during an alcoholic fermentation a simulated wine production was performed as described in Example 2 herein. The grape juice was preincubated for three days with enzymes as described below, followed by the alcoholic fermentation of 11 days and a malolactic fermentation of 10 days.

Three independent experiments were performed using two replicates in each case. In each sample 200 ml grape juice (Pinot Blanc 2007, Germany, pasteurized) was added to a glass flask and continuously mixed with a magnetic stirrer. The samples were aerated throughout the experiment.

Either 100 mg glucose oxidase (Hyderase, Amano, >15,000 u/g) or both 100 mg glucose oxidase and 1 g glucose isomerase (Sigma, G4166—50 g, >350 u/g) were added to the flasks. The incubation was allowed to run at room temperature for 3 days. After this time point the alcoholic fermentation was started by inoculation with re-hydrated freeze dried wine yeast (Saccharomyces cerevisiae Merit. Ferm, Chr. Hansen, 0.1 g/l) to a final concentration of 9E+05 CFU/ml. Rehydration was performed in peptone water (15 g/l Tryptone, Oxoid L 42.9 g/l NaCl, 1.14 g/12% antifoam 1510, BHD 63215) for 10 minutes at room temperature. Eleven days after the start of the alcoholic fermentation the malolactic fermentation was started by addition of O. oeni (Viniflora, Chr. Hansen. Batch no.: 2711097) to the fermented grape juice. Freeze dried O. oeni (0.7 g of 8.2 E+11 CFU/g) was allowed to re-hydrate for 10 minutes in 100 ml of peptone water 15 g/l Tryptone, Oxoid L 42.9 g/l NaCl, 1.14 g/12% antifoam 1510, BHD 63215). Three ml was added to 4000 ml of fermented grape juice, resulting in a final concentration of 4.3*10⁶ CFU/ml. This was allowed to stand for another 10 days at room temperature.

The number of S. cerevisiae colony forming units was determined at a different time point by taking samples from the fermented grape juice and plating serial dilutions on YGC solid medium agar plates followed by an overnight incubation at 30° C.

Sugar levels were determined using a commercial UV based assay supplied by Boehringer Mannheim/R-biopharm (catalog number 10 139 106 035), using the protocol supplied by the provider.

### Results

### Effect of Isomerase on a Stuck Alcoholic Fermentation

During the alcoholic fermentation the sugars in the grape juice are converted to ethanol by the yeast S. cerevisiae.

Treatment with glucose oxidase alone was shown to result in a delayed alcoholic fermentation (stuck fermentation) due to delayed growth of S. cerevisiae (as shown in Table IV). In the must pretreated with glucose oxidase, growth of yeast was very poor during the first days of the alcoholic fermentation. The number of CFUs was below the detection limit at day 1 and was approximately 3 log units lower at day 2 of the alcoholic fermentation. This is a clear indication of a stuck fermentation.

This result was supported by the sugar analysis. While in the non-treated must approx. 60% of the sugar was fermented after 3 days of yeast fermentation, less than 10% was fermented in the GOX pre-treated must.

However, when glucose isomerase was present during the pre-treatment and alcoholic fermentation, the fermentation process behaved almost identical to the fermentation of untreated must. Both the remaining sugar levels and the S. cerevisiae CFU numbers (Table IV) were comparable to the untreated must. In other words; glucose isomerase was able to overcome the stuck fermentation caused by GOX treatment.

TABLE IV
Viable S. cerevisiae cell count during the alcoholic fermentation.

| | | CFU/ml | Total sugar |
|---|---|---|---|
| Days | Treatment | (average) | (g/l) |
| 0 | Control | 7.0 ± 1.4E+05 | 229 ± 4 |
| | GOX | 9.0 ± 4.2E+05 | 225 ± 9 |
| | GOX + Isomerase | 9.0 ± 1.4E+05 | 225 ± 25 |
| 1 | Control | 6.5 ± 2.1E+05 | |
| | GOX | Nd | |
| | GOX + Isomerase | 1.0 ± 0.9E+06 | |
| 2 | Control | 2.2 ± 0.2E+07 | 212 ± 6 |
| | GOX | 5.0 ± 7.1E+04 | 220 ± 6 |
| | GOX + Isomerase | 1.1 ± 0.9E+07 | 209 ± 11 |
| 3 | Control | 6.9 ± 0.9E+07 | 86 ± 64 |
| | GOX | 2.7 ± 3.3E+06 | 207 ± 5 |
| | GOX + Isomerase | 5.1 ± 1.7E+07 | 96 ± 80 |
| 7 | Control | 3.1 ± 0.9E+07 | 22 ± 10 |
| | GOX | 3.2 ± 1.1E+07 | 141 ± 55 |
| | GOX + Isomerase | 4.3 ± 0.3E+07 | 11 ± 8 |
| 9 | Control | 2.7 ± 0.2E+07 | |
| | GOX | 2.0E ± 0.8 + 07 | |
| | GOX + Isomerase | 1.1 ± 1.6E+07 | |
| 16 | Control | 6.9 ± 6.6E+06 | 2 ± 1 |
| | GOX | 2.9 ± 1.0E+06 | 53 ± 12 |
| | GOX + Isomerase | 9.5 ± 9.2E+05 | 0 ± 0 |
| 18 | Control | 2.5 ± 0E+05 | |
| | GOX | 4.0 ± 2.1E+06 | |
| | GOX + Isomerase | 2.0E+05 | |

The grape juice had been pre-treated for three days as described. Yeast was added at t = 0 days.
Nd = below detection limit.

### Conclusion

As shown in this example 3 use of GOX alone may induce significant unwanted stuck fermentation.

The results of this example 3 show that addition of isomerase can help to overcome the negative effects of addition of GOX on the growth of S. cerevisiae generally used for wine production.

### Example 4

### Effect of Glucose Isomerase in Fermentation of Synthetic Grape Juice

In order to investigate the effect of glucose isomerase alone under defined conditions a fermentation of synthetic grape juice was carried out. The grape juice consists of yeast nitrogen base (YNB), tartaric acid and varying amounts of glucose and fructose.

The effect of glucose isomerase is investigated in terms of analyzing the yeast growth and glucose/fructose reduction during the fermentation as well as the ethanol production.

The experiment was carried out in 1 l autoclaved fermentation flasks with 500 ml synthetic grape juice in each and all fermentations were performed in duplicates. The synthetic grape juice media (0.67% YNB, 2.0 g/l tartaric acid, glucose and fructose in different amounts, miliQ water, and pH adjusted with 50% w/w KOH) was inoculated with re-hydrated freeze dried wine yeast (Saccharomyces cerevisiae Merit. Ferm, Chr. Hansen, 0.1 g/l) to a final concentration of 9E+05 CFU/ml.

The enzyme glucose isomerase EC 5.3.1.5 (Sigma G4166, >350 U/g) was added (0.5 g/l) to flasks just before yeast inoculation. The ferments were allowed to run unstirred for 41 days at room temperature (approximately 23° C.).

The number of S. cerevisiae colony forming units, and the sugar levels at the given times were determined as described in example 3. The ethanol concentration was measured according to enzymatic UV-method and protocol supplied by Boehringer Mannheim/R-biopharm (cat. no. 10 176 290 035).

TABLE V
Overview of fermentations and expectations

| | | | | | Potential | |
|---|---|---|---|---|---|---|
| | | Start | | GI | alcohol | |
| No | G/F | Ratio | pH | (g/l) | (vol %) | Expectations |
| 1 (a & b) | 130/130 | 1.0 | 3.6 | 0.0 | 14.7 | High ethanol => |
| 2 (a & b) | 130/130 | 1.0 | 3.6 | 0.5 | 14.7 | stuck without GI |
| 3 (a & b) | 100/160 | 0.6 | 3.6 | 0.0 | 14.7 | High ethanol + |
| 4 (a & b) | 100/160 | 0.6 | 3.6 | 0.5 | 14.7 | imbalanced |
| | | | | | | G/F ratio => |
| | | | | | | stuck without GI |
| 5 (a & b) | 60/100 | 0.6 | 3.6 | 0.0 | 9.0 | Imbalanced G/F => |
| 6 (a & b) | 60/100 | 0.6 | 3.6 | 0.5 | 9.0 | stuck without GI |
| 7 (a & b) | 60/100 | 0.6 | 5.0 | 0.0 | 9.0 | Imbalanced G/F => |
| 8 (a & b) | 60/100 | 0.6 | 5.0 | 0.5 | 9.0 | stuck without GI. |
| | | | | | | Raised pH => |
| | | | | | | Better GI activity |
| Control − | 100/100 | 1.0 | 3.6 | 0.0 | 11.2 | “standard” |
| (a & b) | | | | | | fermentation |
| Control + | 100/100 | 1.0 | 3.6 | 0.5 | 11.2 | without stuck |
| (a & b) | | | | | | |

### Results

### Effect of Glucose Isomerase in Fermentation of Synthetic Grape Juice.

The fermentation of juices with high sugar levels (total sugar=260 g/l) with both balanced and unbalanced glucose/fructose ratios resulted in stuck fermentations when not treated with glucose isomerase. See table V and VI. This shows that high sugar levels alone can cause stuck fermentation. With the isomerase however the fermentations was much faster and all the sugar was fermented.

TABLE VI
Reduction of glucose and fructose during the alcoholic fermentation
in the first 4 experiments. Yeast inoculation at day t = 0 days.

| | | | day | g/L | g/L | g/L | stdev | stdev | stdev |
|---|---|---|---|---|---|---|---|---|---|
| | Average | GI | time | Cglu | Cfruc | Ctotal | glu | fruc | total |
| 1 | 130/130 | − | 0 | 133.9 | 130.0 | 263.8 | 0.0 | 0.6 | 0.6 |
| 1 | pH 3.6 | − | 20 | 2.6 | 22.7 | 25.4 | 0.1 | 3.4 | 3.4 |
| 1 | | − | 30 | 0.4 | 8.5 | 8.9 | 0.1 | 0.9 | 0.9 |
| 1 | | − | 35 | 0.1 | 6.8 | 7.0 | 0.0 | 3.0 | 3.0 |
| 2 | 130/130 | + | 0 | 132.6 | 130.4 | 263.0 | 3.1 | 3.7 | 6.7 |
| 2 | pH 3.6 | + | 20 | 0.1 | 4.4 | 4.5 | 0.0 | 0.6 | 0.6 |
| 2 | | + | 30 | −0.2 | 0.9 | 0.8 | 0.2 | 0.3 | 0.0 |
| 2 | | + | 35 | 0.0 | 0.5 | 0.5 | 0.0 | 0.0 | 0.1 |
| 3 | 100/160 | − | 0 | 102.3 | 157.8 | 260.1 | 1.8 | 1.8 | 0.0 |
| 3 | pH 3.6 | − | 20 | 1.5 | 24.0 | 25.4 | 1.3 | 15.1 | 16.4 |
| 3 | | − | 30 | 0.2 | 11.0 | 11.3 | 0.3 | 9.6 | 9.9 |
| 3 | | − | 35 | 0.1 | 7.9 | 8.0 | 0.1 | 7.6 | 7.8 |
| 4 | 100/160 | + | 0 | 99.7 | 156.9 | 256.7 | 0.6 | 0.6 | 0.0 |
| 4 | pH 3.6 | + | 20 | 0.1 | 4.8 | 4.9 | 0.1 | 3.7 | 3.8 |
| 4 | | + | 30 | 0.0 | 1.0 | 1.1 | 0.0 | 0.7 | 0.7 |
| 4 | | + | 35 | 0.0 | 0.7 | 0.7 | 0.0 | 0.4 | 0.4 |

The set-ups with low and unbalanced sugars (60/100) are supposed to represent production of a wine with a reduced final alcohol concentration. Here the effect of GI is observed at two different pH values: pH 3.6 and pH 5.2 respectively. At elevated pH the enzyme is proved to be more active as expected, comparing ferments 60/100 with isomerase at pH 3.6, day 6 with pH 5.2, day 6 showing a total of 18 and 5 g/l residual sugar. However the fermentations treated with GI at both pH values are more efficient than the untreated fermentations where it takes 4 more days for the yeast to complete the fermentations.

When testing the effect of glucose isomerase in a more standard like juice with balanced glucose/fructose ratio and a total amount of sugar of 200 g/l the results were more or less the same with improved alcohol fermentation with the enzyme.

TABLE VII
Reduction of glucose and fructose during the alcoholic fermentation
in set-up 5-10. Yeast inoculation at day t = 0 days.

| | | | day | g/L | g/L | g/L | stdev | stdev | stdev |
|---|---|---|---|---|---|---|---|---|---|
| | Average | GI | time | Cglu | Cfruc | Ctotal | glu | fruc | total |
| 5 | 60/100 | − | 0 | 60.9 | 100.4 | 161.3 | 4.3 | 1.8 | 6.1 |
| 5 | pH 3.6 | − | 6 | 3.3 | 27.3 | 30.7 | 0.3 | 1.2 | 1.5 |
| 5 | | − | 9 | 0.1 | 6.6 | 6.7 | 0.1 | 0.7 | 0.8 |
| 5 | | − | 13 | 0.0 | 0.5 | 0.5 | 0.0 | 0.1 | 0.1 |
| 6 | 60/100 | + | 0 | 59.2 | 100.8 | 160.0 | 3.1 | 6.1 | 9.2 |
| 6 | pH 3.6 | + | 6 | 1.1 | 16.8 | 17.9 | 0.1 | 1.5 | 1.7 |
| 6 | | + | 9 | 0.0 | 0.2 | 0.2 | 0.0 | 0.2 | 0.2 |
| 6 | | + | 13 | 0.0 | 0.1 | 0.1 | 0.0 | 0.0 | 0.0 |
| 7 | 60/100 | − | 0 | 61.7 | 101.3 | 163.0 | 1.8 | 6.8 | 8.6 |
| 7 | pH 5.0 | − | 6 | 5.4 | 33.9 | 39.3 | 2.2 | 6.9 | 9.1 |
| 7 | | − | 9 | 0.2 | 8.8 | 9.0 | 0.1 | 3.0 | 3.2 |
| 7 | | − | 13 | 0.0 | 0.6 | 0.6 | 0.0 | 0.2 | 0.2 |
| 8 | 60/100 | + | 0 | 60.9 | 101.7 | 162.6 | 1.8 | 1.2 | 3.1 |
| 8 | pH 5.0 | + | 6 | 0.2 | 4.7 | 4.9 | 0.1 | 5.9 | 6.0 |
| 8 | | + | 9 | 0.0 | 0.1 | 0.1 | 0.0 | 0.1 | 0.1 |
| 8 | | + | 13 | 0.0 | 0.0 | 0.1 | 0.0 | 0.0 | 0.0 |
| 9 | 100/100 | − | 0 | 99.3 | 98.2 | 197.6 | 3.7 | 3.7 | 7.4 |
| 9 | pH 3.6 | − | 6 | 16.6 | 44.2 | 60.9 | 0.9 | 0.6 | 1.5 |
| 9 | Control − | − | 9 | 3.6 | 20.9 | 24.8 | 0.9 | 0.2 | 1.5 |
| 9 | | − | 13 | 0.2 | 6.5 | 6.7 | 0.1 | 1.4 | 1.6 |
| 9 | | − | 20 | 0.0 | 0.9 | 1.0 | 0.0 | 0.3 | 0.3 |
| 10 | 100/100 | + | 0 | 101.9 | 100.0 | 201.9 | 0.0 | 0.0 | 0.0 |
| 10 | pH 3.6 | + | 6 | 5.5 | 26.6 | 32.1 | 1.3 | 2.5 | 3.7 |
| 10 | Control + | + | 9 | 0.1 | 3.3 | 3.3 | 0.0 | 0.0 | 0.0 |
| 10 | | + | 13 | 0.0 | 0.3 | 0.3 | 0.0 | 0.0 | 0.0 |
| 10 | | + | 20 | 0.0 | 0.2 | 0.2 | 0.0 | 0.0 | 0.0 |

The cell counts of S. cerevisiae supports these data obtained from measuring sugars. During the first two weeks of the fermentation an almost similar growth of yeast is seen in all set-ups, but hereafter the yeasts tend to die out faster in fermentations treated with glucose isomerase. This indicates the fermentations are completed faster when treated with the enzyme.

TABLE VII
Viable CFU counts of S. cerevisiae during alcoholic fermentation.
Yeast was added at t = 0 days.

| | ◯ | | ◯ | | ◯ | | ◯ | | ◯ | |
|---|---|---|---|---|---|---|---|---|---|---|
| Day | 1 | 2 | 3 | 4 | 5 | 6 | 7 | 8 | 9 | 10 |
| 0 | 7.9 ± | 8.9 ± | 9.4 ± | 1.0 ± | 8.9 ± | 9.6 ± | 4.8 ± | 1.0 ± | 8.8 ± | 9.7 ± |
| | 0.2E+05 | 0.1E+05 | 0.2E+05 | 0.1E+06 | 0.2E+05 | 0.9E+05 | 6.7E+05 | 0.01E+06 | 2.0E+05 | 1.7E+05 |
| 2 | 2.5 ± | 4.6 ± | 3.3 ± | 4.5 ± | 4.9 ± | 7.0 ± | 2.7 ± | 3.9 ± | 4.6 ± | 5.9 ± |
| | 0E+07 | 0.3E+07 | 1.1E+07 | 0.7E+07 | 0.4E+07 | 0.6E+07 | 2.9E+07 | 3.9E+07 | 0.5E+07 | 0.4E+07 |
| 13 | 2.0 ± | 2.6 ± | 1.7 ± | 2.3 ± | 3.4 ± | 1.2 ± | 3.2 ± | 2.6 ± | 2.4 ± | 2.9 ± |
| | 0.2E+07 | 0.3E+07 | 0.4E+07 | 0.7E+07 | 0.8E+07 | 0.3E+07 | 0.2E+07 | 0.5E+07 | 1.3E+07 | 0.6E+07 |
| 27 | 7.7 ± | 5.9 ± | 8.3 ± | 6.6 ± | 4.9 ± | 2.3 ± | 4.6 ± | 5.7 ± | 9.5 ± | 2.0 ± |
| | 0.7E+06 | 0E+06 | 0.8E+06 | 0.4E+06 | 3.8E+06 | 0E+05 | 1.6E+06 | 6.2E+05 | 0.7E+06 | 1.5E+06 |
| 41 | 5.6 ± | 1.0 ± | 1.8 ± | <1.0 ± | 2.5 ± | 1.0 ± | 4.5 ± | 2.0 ± | 1.0 ± | 1.2 ± |
| | 1.7E+05 | 0E+04 | 1.1E+05 | E+04 | 0.7E+03 | 0E+03 | 3.8E+04 | 1.9E+04 | 0.1E+05 | 0E+05 |

Open symbols (◯) represent experiments without glucose isomerase and closed () symbols represent experiments with the enzyme.

### Conclusion

As shown in example 4 the use of glucose isomerase results in a more efficient alcoholic fermentation and reduces the risk of stuck fermentation considerably. This applies to grape juices with both high and low sugar levels as well as balanced and unbalanced ratios of glucose and fructose.

### REFERENCES

1. U.S. Pat. No. 4,675,191 (Novo Industri, Denmark—published 1987)

1. A method for production of an alcoholic beverage, comprising following steps:
(1): treating a beverage starting solution during the alcohol yeast fermentation with an effective amount of glucose isomerase to maintain the glucose/fructose ratio closer to 1:1 in the solution;
and thereafter,
(2): further adequate steps to produce the beverage of interest.

2. The method of claim 1, wherein
the effective amount of glucose isomerase is added before the actual start of the alcohol yeast fermentation i.e. it is added to the unfermented solution;
or
the effective amount of glucose isomerase is added during the alcohol yeast fermentation, preferably at the beginning of the fermentation, e.g. at roughly the same time as yeast is added to the solution.

3. The method of claim 1, wherein the effective amount of glucose isomerase enzyme during step (1) is so that:
(A): at the end of yeast alcohol fermentation the sugar content in the solution is less than 4 g/l.

4. The method of claim 3, wherein the sugar content in the solution is less than 0.1 g/l.

5. The method of claim 1, wherein the effective amount of the glucose isomerase enzymes is:
(i): a glucose isomerase activity between 100 and 5,000,000 international units per hl of solution.

6. The method of claim 1, wherein the following step is performed before the start of the alcohol yeast fermentation of step (1) of claim 1:
(A): treating an unfermented beverage starting solution with an effective amount of glucose oxidase in the presence of oxygen for a period of time adequate to convert at least a portion of the glucose in the solution into gluconic acid.

7. The method of claim 6, wherein the glucose isomerase is added together with the glucose oxidase to the unfermented solution.

8. The method of claim 6, wherein the effective amount of the glucose oxidase enzymes is:
(i): a glucose oxidase activity roughly between about 1,000 and 50,000,000 international units per hl of solution.

9. The method of claim 7, wherein the effective amount and the period of time for the two glucose oxidase/isomerase enzymes during step (1) is so that:
(A): the sugar content in the unfermented solution is reduced by at least 17%.

10. The method of claim 1, wherein the alcoholic beverage is a fruit cider.
